(19) United States
(12) Patent Application Publication
(10) Pub. No.: US 2026/0219295 A1
(43) Pub. Date: Jul. 30, 2026

(54) SYSTEM AND METHOD FOR AUTOMATICALLY LOADING AND TESTING AFM-PROBES

(71) Applicant: Nearfield Instruments B.V., Rotterdam (NL)

(72) Inventors: Hamed SADEGHIAN MARNANI, Rotterdam (NL); Wouter Arie DE ZEEUW, Breda (NL); Irene BATTISTI, Rotterdam (NL)

(21) Appl. No.: 19/142,084

(22) PCT Filed: Dec. 20, 2023
(86) PCT No.: PCT/NL2023/050672

§ 371 Date: Jun. 20, 2025

(30) Foreign Application Priority Data
Dec. 21, 2022 (NL) 2033786

(51) Int. Cl. G01Q 60/40; G01Q 20/02

(52) U.S. Cl. CPC G01Q 60/40; G01Q 20/02

(57) ABSTRACT

An apparatus (2) is disclosed for automated unloading AFM-probes (10) from a probe package (1) and loading the probes after being individually characterized into a probe cassette (3) for use by an AFM-device. The apparatus comprises: a cantilever characterization station (21) for characterizing a cantilever of individual probes; a tip characterization station (22) for characterizing a tip of individual probes; a probe manipulator (23) to transfer AFM-probes from the probe package (1) to the probe cassette (3).

### BACKGROUND

The present application relates to an apparatus for automatically loading and testing AFM-probes.

The present application further relates to a method for automatically loading and testing AFM-probes.

AFM-probes as purchased from a probe supplier and typically supplied in a source probe carrier, e.g. in a gel pack or on a wafer. Each wafer or gel pack comprises a plurality of probes (e.g. from about 10 in a gel pack to a few hundred, e.g. 400 in a wafer). In order to be used in an AFM-imaging device, the AFM-probes need to be transferred to a destination probe carrier, or be directly installed in the AFM-imaging device and certain probe characteristics (for example calibration data) need to be known for each individual probe. Conventionally, these steps are performed manually, which is time consuming, for example requiring one hour of manual effort for each probe. For this reason, the calibration step is often omitted. To keep up with the expected demand for calibrated AFM-probes, an automated setup to perform both actions is needed.

Reference is made to the following background information.

U.S. Pat. No. 5,705,814 discloses a scanning probe microscope having automatic probe exchange and alignment. The scanning probe microscope and corresponding method provided for automated exchange and precise alignment of probes, wherein one or more additional stored probes for installation onto a probe mount are stored in a storage cassette or a wafer. A selected probe is aligned to a detection system, and the aligned probe is then clamped against the probe mount. Clamping is performed using a clamp which is disabled when removing a replacement probe from the storage cassette, enabled when installing the probe on the probe mount and disabled when releasing the probe at a later time for subsequent probe exchange. Probe alignment is automated using signals from the probe detection system or by forming an optical image of the probe using a camera or similar technique and determining probe positioning using pattern recognition processing of the probe image to allow probe removal and exchange without operator intervention. Techniques for error checking are employed to ensure proper probe installation and operation.

CN108856127 discloses an integrated atomic force microscope probe storing, transporting and cleaning device. The integrated device is composed of probe mounting units, a final assembly box and a cleaning module. Probes are mounted and fixed in slots of gel fixture blocks. The probe mounting units can be placed in the center of the cleaning module, wherein the probes are cleaned ultrasonically, and protecting slots are formed in the gel locking blocks to protect cantilevers of the probes, so that the cleaning quality is improved and the safety is ensured.

EP1662246 discloses a probe replacement method for a scanning probe microscope for measuring the surface of a sample. The scanning probe microscope has a cantilever with a probe, and has a measurement unit for measuring a physical quantity between the probe and sample. The scanning probe microscope is provided with a cantilever mount, a cantilever cassette, an XY stage and Z stage for moving the cantilever cassette, and an optical microscope. The method has a first step for performing alignment between the cantilever mount and the cantilever cassette, selecting a cantilever from the cantilever cassette, and mounting the cantilever thus selected on the cantilever mount; and a second step for moving an optical microscope and setting the mounted cantilever in a prescribed position in the field of view after the cantilever is mounted in the scanning probe microscope. In the second step, a step is provided for moving the optical microscope side or the cantilever side and performing positional adjustment.

US2010/037360 A1 discloses an automatic probe exchange system for a scanning probe microscope (SPM) that exchanges probes between a probe mount on the SPM and a probe mount on a probe tray based on differential magnetic force. When the magnetic force on the SPM side is greater, the probe is attached to the probe mount on the SPM. When the magnetic force on the probe tray side is greater, the probe is attached to the probe mount on the probe tray. The magnetic force on the probe tray side is varied by moving the magnets that generate the magnetic force on the probe tray side closer to or further from the probe.

### SUMMARY

It is an object to address the above-mentioned need. In accordance therewith, according to a first aspect of the disclosure, a system is provided for automated unloading AFM-probes from a source probe carrier, such as a probe cassette, a gel box, a tabbed wafer and the like, and loading the probes after being individually characterized into a destination probe carrier for use by an AFM-device, or be directly installing the probe into the AFM device. The disclosed system comprises:
a cantilever characterization station for characterizing a cantilever of individual probes;
a tip characterization station for characterizing a tip of individual probes;
a probe manipulator to transfer AFM-probes from the probe carrier to the destination probe carrier or to directly install the probe in the AFM-device.

In addition the disclosed system may include further system components, such as a cleaning station for cleaning the probes, e.g. a chemical cleaning station or a plasma cleaning station. Alternatively, or additionally, the disclosed system may comprise a cleanliness and integrity verification station. In an example, the system is configured to cause the cleanliness and integrity verification station to verify the cleanliness of the probe and to selectively cause the cleaning station to perform a cleaning operation if this is required to meet quality requirements.

The components of the system may be integrated in a single system housing. Alternatively, two or more of the components may have a separate housing.

It is not necessary that the above-mentioned components perform their function in the same order as the order in which these components are presented.

For example in some embodiments the probe manipulator first removes the probes one by one from the source probe carrier, before the cantilever characterization station and the tip characterization station perform the characterizations steps and before the probe manipulator transfers the probes into the destination probe carrier or directly installs the probe.

A probe manipulator is for example configured to automatically remove probes from the source probe-carrier by one or more of the processes lasercut, mechanical yielding, torsion, etch, and/or vacuum manipulation. According to another option a probe is removed from the probe carrier with a dicing step. Therewith for example a wafer is adhered to a UV active membrane film and then diced by diamond cutting wheel and subsequently picked from the membrane.

The cantilever characterization station is for example configured to characterize an AFM probe cantilever on the basis of one or more of the properties: eigenfrequency, stiffness, shape and the like. Suitable methods for such characterization are (Scanning) Laser Doppler Vibrometry, AFM, Electrostatic Force Balancing and the like.

The tip characterization station is for example configured to characterize an AFM probe tip on the basis of one or more of the properties: tip shape, stiffness, radius, length, adhesion, conductivity, permeability, aspect ratio, and the like. Suitable methods for tip characterization are for example Laser Doppler Vibrometry, SEM, CD-SEM, AFM etc. In an example the tip characterization station is configured to perform a measurement to ascertain that a tip whisker profile (also denoted as tip whisker slenderness) meets the requirement that a width of the tip is smaller than a predetermined threshold value for a predetermined length. Alternatively or additionally the tip characterization station is configured to characterize the actual tip shape in terms of its radius and full profile along its length.

In some embodiments the apparatus is configured to characterize the AFM probe body using optical methods. Exemplary properties for characterization by optical methods are cleanliness, recognizing markings/IDs, shape, defects, etc.

In some embodiments the apparatus is configured to perform a functional characterization, for example by performance measurements, or by rendering sample AFM images of fiducial samples.

It is noted that it is not essential that the probes are removed from the source probe carrier before characterization can be performed. For example in some embodiments characterization of the cantilever or of the tip of a probe may take place while the probe is still in the source probe carrier. Laser Doppler Vibrometry is an example of a method that renders it possible to characterize the cantilever or the tip of a probe while it is still in the probe-package. In an alternatively approach, this methodology is employed with the probe arranged on a measurement seat and the reflective bottom of the cantilever vibrometer is the object of the measurement. Also optical methods are suitable for use as characterization tool while a probe is still in the source probe carrier.

As another example characterization of the cantilever or of the tip of a probe may take place after the probe is positioned in the probe cassette. This approach is however less preferred because it could occur that the result of characterization is that a probe that is already placed in the probe cassette does not comply with predetermined requirements.

In an embodiment the system comprises a probe characteristics memory and a controller that is configured to store in the probe characteristics memory for each probe the location of the probe as well as the data characterizing the probe, such as the measured value for the stiffness of the cantilever and the tip characteristics.

Alternatively or additionally, an embodiment of the system is configured to provide information for use by an AFM-device indicative for the location of the probe in the destination probe carrier as well as the data characterizing the probe, such as the measured value CL for the stiffness of the cantilever and the tip characteristics. The information is for example accessible to an AFM-device using the probe in that it is encoded into a QR code provided on a surface of the destination probe carrier and/or written into a data carrier that is embedded into the destination probe carrier and/or stored in a database accessible to the AFM-imaging device via communications/networking technology (internet).

According to a second aspect a method for automated unloading AFM-probes from a source probe carrier and loading the probes after being individually characterized into a probe cassette for use by an AFM-device, the method comprising:
receiving the source probe carrier;
characterizing a cantilever of individual probes received in the source probe carrier;
characterizing a tip of individual probes received in the source probe carrier;
transferring a characterized AFM-probe to the destination probe carrier or directly installing the characterized probe in the AFM-imaging device.

As noted above, the source probe carrier with which the probes are provided maybe one of several variants, such as a probe cassette, a gel box, a tabbed wafer package and the like.

Also various options are available for a destination probe carrier. According to one option, the characterized probe is transferred into a gel pack, e.g. for long term storage or for yield relative to the one or more properties for which the probe is characterized. According to another option the destination probe carrier is a probe cassette, e.g. a cassette received from a customers that is returned, a pre-filled cassette from a probe supplier or another cassette received as the source probe carrier which is returned as the destination probe carrier, after its contents have been re-organized. The source probe carrier and the destination probe carrier do not need to be of the same type.

### BRIEF DESCRIPTION OF THE DRAWINGS

These and other aspects of the disclosure are described in more detail with reference to the drawings. Therein:

FIG. 1 schematically shows an embodiment of a method according to the present disclosure;

FIG. 2 schematically shows an exemplary probe carrier as well as a section thereof in more detail;

FIG. 2A shows a portion of a probe;

FIG. 3 schematically shows an embodiment of a system according to the present disclosure;

FIGS. 4A, 4B show a component of the system of FIG. 3 in a first and a second operational stage respectively;

FIG. 5 shows an exemplary probe cassette;

FIG. 5A shows a section of the probe cassette in more detail;

FIGS. 6A, 6B respectively show a top-view and a front-view of another embodiment of the system according to the present disclosure.

### DETAILED DESCRIPTION OF EMBODIMENTS

Terminology used for describing particular embodiments is not intended to be limiting of the invention. As used herein, the singular forms “a”, “an” and “the” are intended to include the plural forms as well, unless the context clearly indicates otherwise. The term “and/or” includes any and all combinations of one or more of the associated listed items. It will be understood that the terms “comprises” and/or “comprising” specify the presence of stated features but do not preclude the presence or addition of one or more other features. It will be further understood that when a particular step of a method is referred to as subsequent to another step, it can directly follow said other step or one or more intermediate steps may be carried out before carrying out the particular step, unless specified otherwise. Likewise it will be understood that when a connection between structures or components is described, this connection may be established directly or through intermediate structures or components unless specified otherwise.

The invention is described more fully hereinafter with reference to the accompanying drawings, in which embodiments of the invention are shown. In the drawings, the absolute and relative sizes of systems, components, layers, and regions may be exaggerated for clarity. Embodiments may be described with reference to schematic and/or cross-section illustrations of possibly idealized embodiments and intermediate structures of the invention. In the description and drawings, like numbers refer to like elements throughout. Relative terms as well as derivatives thereof should be construed to refer to the orientation as then described or as shown in the drawing under discussion. These relative terms are for convenience of description and do not require that the system be constructed or operated in a particular orientation unless stated otherwise.

### DETAILED DESCRIPTION OF EMBODIMENTS

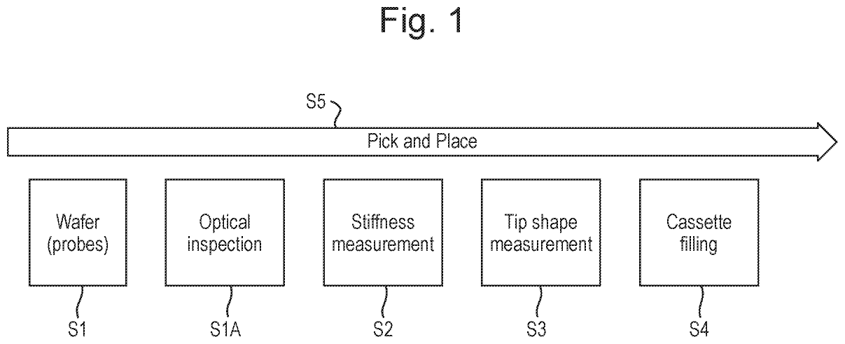

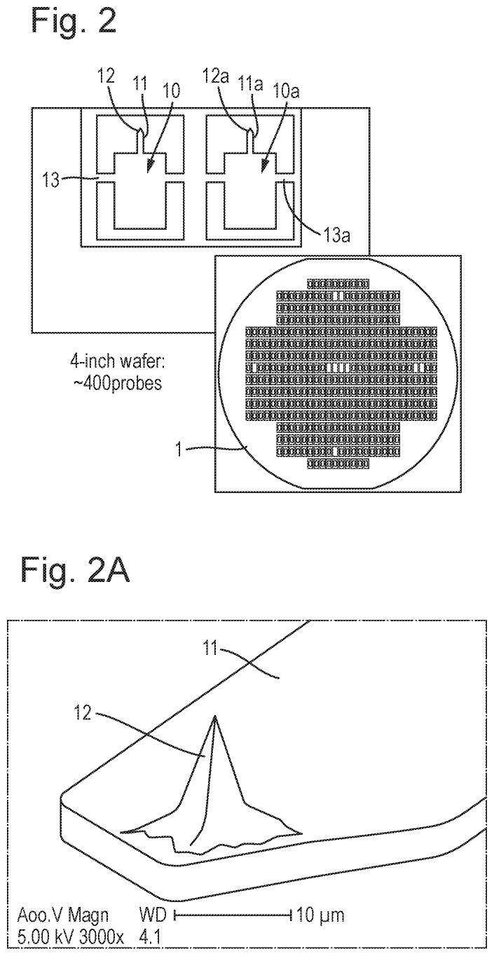

FIG. 1 schematically shows steps of a method for automated unloading AFM-probes from a probe package and loading the probes after being individually characterized into a probe cassette for use by an AFM-device. In step S1 a probe package is received. The probe package as received from a probe supplier is for example a gel packs or a wafer. Each wafer or gel pack comprises a for example a few hundreds of probes. By way of example FIG. 2 shows a 4-inch wafer 1 with about 400 probes 10, 10a. An individual probe 10 comprises a cantilever 11 with a tip 12 and is fixed in the wafer 1 with support arms 13. A detailed view of an individual probe is shown in FIG. 2A.

In some examples step S1 involves a removal of individual probes from the probe package before further steps are performed. In alternative examples probe characterization partly or fully takes place while the probes still are in the probe package. In that alignment steps may be performed in step S1 to properly align the probe package (1) within a characterization station for characterization of a particular probe (10) within the probe package (1). In some examples step S1 involves a sub step wherein each probe is provided with a unique identification number (ID) with which its characteristics are associated.

In step S2 the cantilever of individual probes is characterized. In this example the cantilever characterization of individual probes is a stiffness measurement, e.g. a Z-stiffness and/or a Rx stiffness measurement. Alternatively or additionally other dynamical properties, such as higher order mode shapes and eigenfrequencies, are assessed in this step.

In step S3, the tip of individual probes is characterized. In this case, step S3 is a tip-shape measurement. In one example, the shape of the tip is determined with an AFM-measurement. In another example, the tip is used to render a test image from a test sample having predetermined properties and the test image is analyzed to characterize the tip. In one example the test sample has a structure of which the reaction observed in the test image depends on the way it is interrogated by the probe, dependent on the specific properties of the latter. In one example the test sample the test sample comprises a cavity of a predetermined size and the reaction observed in the test image depends on whether or not the tip fits into that cavity. In step S4 the probes are loaded into a probe cassette. Additionally step S4 may involve an automated cleaning of cassette and/or Probes.

Step S5 represents the act of displacing a probe, or a collection of probes.

In some embodiments step S5 involves a displacement of the source probe carrier along various characterization stations capable to characterize individual probes while they are still within the source probe carrier. Examples of such characterization stations are a Laser Doppler Vibrometry station and an optical inspection station. In other embodiments step S5 involves a displacement of a specific probe. Step S5 may for example placing an individual probe in an AFM-device to image a reference sample.

FIG. 1 shows a additional step S1A wherein an optical inspection is performed. Therein a top side and/or a bottom side of the probe are subjected to the optical inspection. The optical inspection step S1A may additionally serve to provide input for performing navigation for picking, placing and aligning the probe to the measurement stations and carriers. The optical inspection S1A may be applied to individual probes or to a set of probes, while they are present in the probe package or after they are loaded into the probe cassette. In an example it is verified in step S1A whether or not the assigned probe ID is clearly readable. As another example it is verified that the probe is free from particles and/or debris.

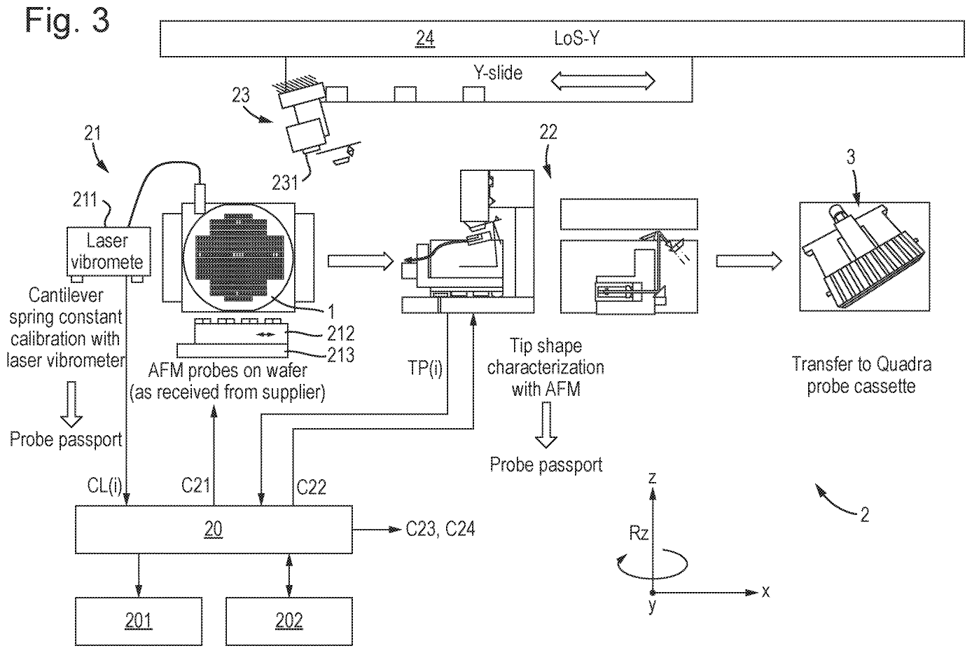

FIG. 3 schematically shows an apparatus 2 for automated unloading AFM-probes from a probe package 1 and loading the probes after being individually characterized into a probe cassette 3 for use by an AFM-device. As shown in FIG. 3, the apparatus 2 comprises a cantilever characterization station 21 for characterizing a cantilever of individual probes. In the embodiment shown, the cantilever characterization station 21 comprises a Laser Doppler Vibrometer 211. The Laser Doppler Vibrometer 211 is configured to measure a cantilever spring constant for each cantilever of a probe while it is still packaged in the probe package 1. Upon completion of the measurement it submits the measured value CL(i) for each probe i in the package 1 to a controller 20. The controller 20 issues control signals C21 for example to control a positioning table 213 of a probe package carrier 212 to position the probe package 1 for allowing the laser vibrometer 211 to measure subsequent probes in the package 1. It is an advantage of the embodiment as shown in FIG. 3 that the cantilever characterization can be performed while the probes are still within the package 1.

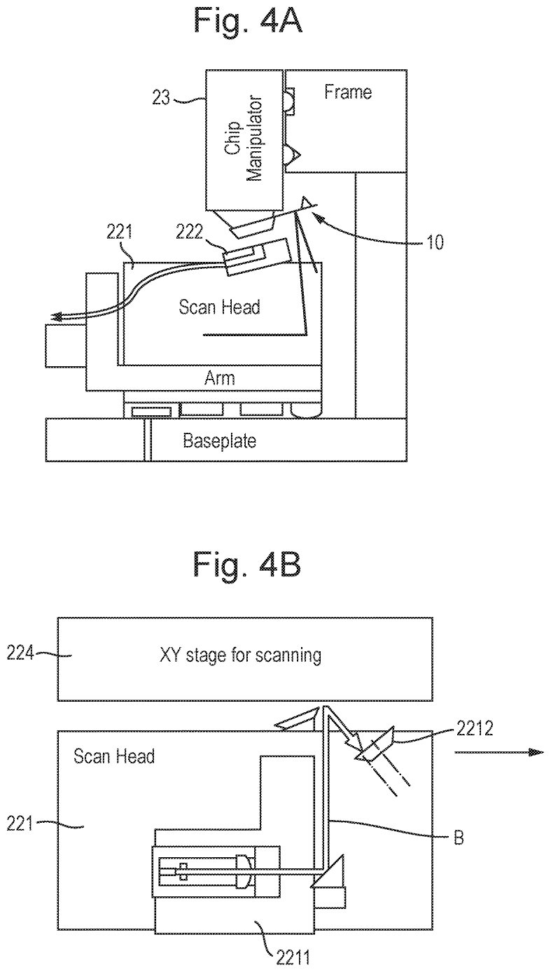

The apparatus 2 further comprises a tip characterization station 22 for characterizing a tip of individual probes. In the example shown the probe manipulator 23, controlled by control signal C23, is configured to automatically remove probes from the probe-package by one or more of the processes lasercut, mechanical yielding, torsion, etch. The probe manipulator 23 has a probe manipulation head 231 with which it temporarily holds the probe for transport to the tip characterization station 22 and for subsequent manipulations. The probe manipulator 23 is mounted on a pick and place unit 24 that controllable positions and orientates the probe manipulator 23 in accordance with control signals C24 from the controller 20. In this example the probe manipulator 23 can be controllably positioned in three orthogonal directions x, y, z and is rotatable around the z-axis (Rz). In other examples the pick and place unit 24 may provide for more or less degrees of freedom of movement of the probe manipulator 23. It is noted that it is alternatively possible that the probe manipulation head is also used to remove individual probes from the source probe carrier. The tip characterization station 22 is shown in more detail in FIGS. 4A and 4B. As shown in FIGS. 4A, 4B the tip characterization station 22 amongst others comprise a scan head 221 and a vacuum holder 222 to temporarily hold an individual probe 10 to be characterized after it is loaded thereon by the probe manipulator (23). It is noted that alternatively or additionally one or more tip characterization steps may take place while the probe is held by the probe manipulator 23. The scan head 221 is shown in more detail in FIG. 4B. The scan head 221 comprises an optical beam generator 2211, such as a laser, to generate and direct an optical beam B towards a side of the cantilever of the probe 10 opposite its tip. The scan head 221 further comprises an optical detector 2212 to detect a reflection of the optical beam B at the cantilever. An XY-scanning stage 224 is provided to hold a test sample and to provide for a relative movement of the test sample with respect to the tip of the probe in the plane XY in order to scan the surface of the test sample with the tip. In an alternative embodiment the scan head 221 is scanned in the directions X and Y and the test sample is kept stationary. Output signals of the optical detector 2212 are used to determine tip characteristics TP(i) of the probe loaded onto the vacuum holder 222. The controller issues control signals C23 to control the probe manipulator 23 for loading each probe onto the vacuum holder 222 and control signals C22 for controlling the tip characterization station 22 to perform the characterization. Subsequent to performing the characterization, the controller 20 issues further control signals C23 to the probe manipulator 23 to load each probe 10 from the tip characterization station 22 to a respective position in a destination probe carrier, such as a probe cassette 3. For each probe, the controller 20 stores the location of the probe 10 in a memory 201 as well as the data characterizing the probe, such as the measured value CL(i) for the stiffness of the cantilever and the tip characteristics TP(i). Alternatively the probe manipulator 23 directly places the probe in an AFM device.

In the embodiment shown, the controller 20 reads instructions from a computer program in instruction memory 202. The instructions specify how the controller 20 is to control the components of the apparatus. The instruction memory 202 is for example a non-volatile record carrier like a ROM. Alternatively the instruction memory is a rewritable memory allowing reprogramming and upgrading the apparatus. In some other embodiments the controller is provided as dedicated hardware. In that case an instruction memory is superfluous.

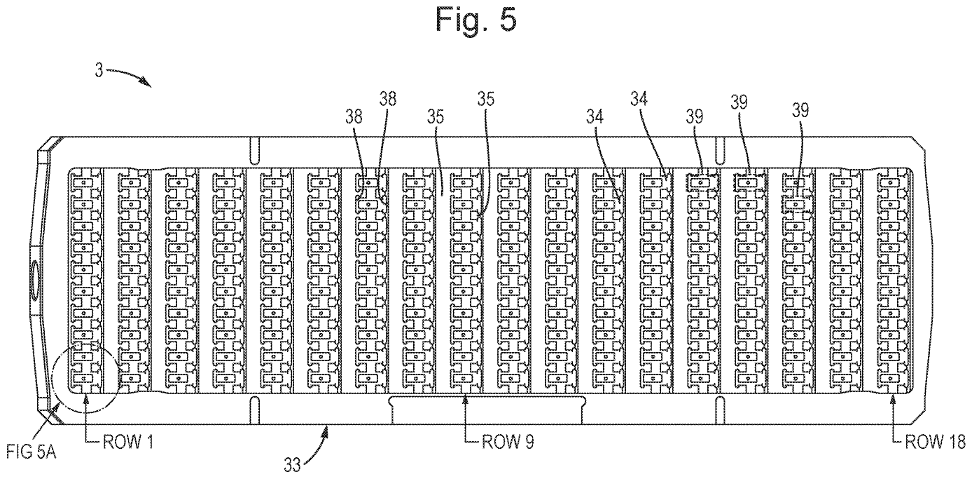

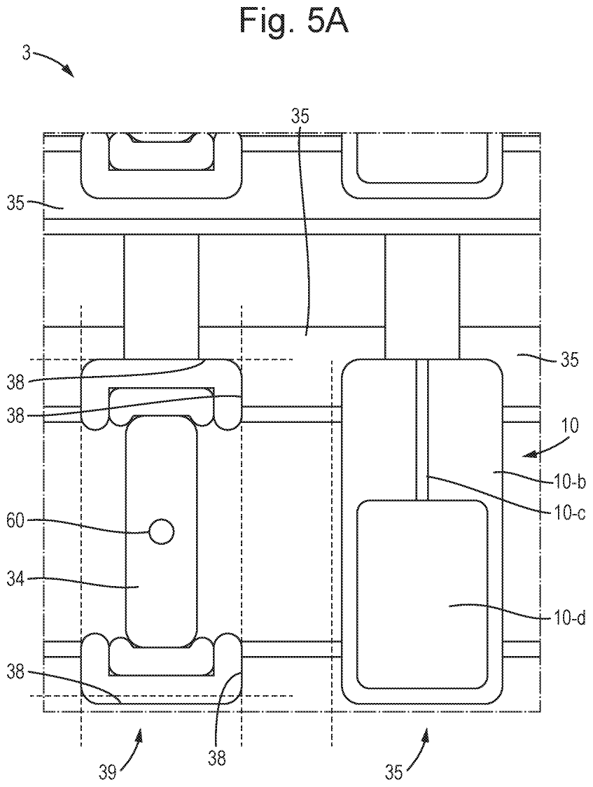

An exemplary probe cassette 3 is shown in more detail in FIG. 5 and FIG. 5A depicts a part of the probe cassette 3. Further details are also published in PCT-application WO 2022/114956. The probe cassette shown in FIG. 5 comprises a main body 33 including a support face 34 for supporting a probe. Provided to the support face is a plurality of physical confinement elements 35. The physical confinement elements provide a plurality of engagement faces 38 disposed along a perimeter of a predefined holding position so as to define a pocket 39 for holding a probe, wherein the pocket is dimensioned to restrict a lateral shift of the probe in any direction along the support face. In some embodiments, e.g. as shown, at least part of the physical confinement elements 35 can be formed of protrusions, e.g. ridges, extending in a direction away from the support face 34, typically transverse thereto. As such, the engagement faces 38 disposed along a perimeter of a predefined holding position physical confinement elements can be understood to be formed by sidewall portions of the protrusions 35.

FIG. 5A depicts a part of the probe cassette 3 holding a single probe 10 in a predefined position. The probe 10 comprises a main body 10-b and a cantilever 10-c extending from a central region 10-d with a flat surface. As can be seen, in this particular arrangement the probe is confined between sidewalls, engagement faces 38, of three physical confinement elements 35, ridges, even though edges of the probe body 10-b have been damaged due to prior handling with a tweezer. At the bottom the probe is confined by the support face. Typically, the cassette is used in an upright position so that probes rest of the support face under the gravitational force. At least a picking or placing operation the pocket is open from a top side so that a probe may be suitably placed into or lifted from the pocket by pick and place tool, e.g. a pick and place tool comprising a vacuum nozzle arrange to engage with the probe, e.g. with a flat top surface of the probe body 10-b. Since the engagement faces 38 are provided around a perimeter of the predefined holding position, that is around the probe, the probe is laterally confined within the pocket. Confining the probe between the physical confinement elements restricts lateral motion along the support face. Additionally, said confinement restricts rotation of the probe along the support face. As its bottom surface the probe is bound by the support face surface on which it rests so translation and rotation in directions towards the support face 34 is likewise restricted. Alternatively, or additionally, the pick and place unit, for example unit 24 in FIG. 3 has in addition to XYZ stages a rotation stage RZ to rotate the probe if necessary to compensate for any rotation variation that occurs in the process or is introduced by the source probe carrier so as to properly align the probe into the target probe carrier.

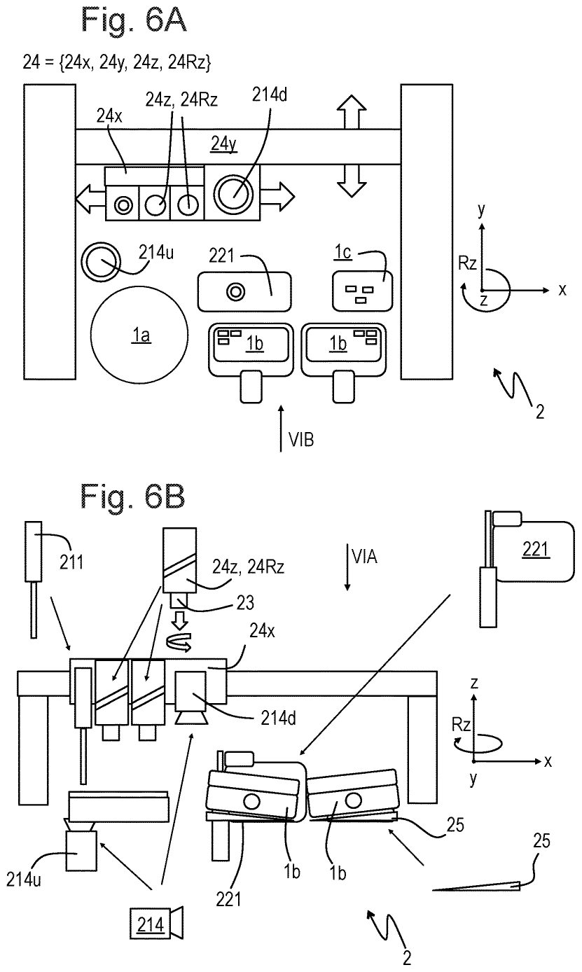

FIGS. 6A, 6B respectively show a top-view and a front-view of another embodiment of the system 2 according to the present disclosure. In FIG. 6B, the viewing direction of FIG. 6B is denoted with VIB. In FIG. 6B, the viewing direction of FIG. 6A is denoted with VIA.

The top-view of FIG. 6A shows exemplary source/destination probe carriers, comprising a probe wafer la, a probe cassette 1b, for example as shown in FIGS. 5, 5A and a probe gel box 1c. FIGS. 6A, 6B shows further components 24x, 24y of a pick and place unit 24 for controllably translating probe characterization components and an end-effector Z+Rz stage 24z, 24Z in the directions x, y. The end-effector 24z, 24Z provides for controllable z-positioning and rotation around the z-axis of the probe manipulator 23. The probe characterization components comprise a Laser Doppler Vibrometer 211 and a downward facing camera 214d. Also an upward facing camera 214u is provided. The cameras 214u, 214d form an optical inspection station for performing an optical inspection a probe at mutually opposite sides. FIG. 6B shows that one of the probe cassettes 1b is placed in a scan head 221 of an AFM sample measurement station. Another one of the probe cassettes 1b is supported by a cassette dock cassette dock 25.

In interpreting the appended claims, it should be understood that the word “comprising” does not exclude the presence of other elements or acts than those listed in a given claim; the word “a” or “an” preceding an element does not exclude the presence of a plurality of such elements; any reference signs in the claims do not limit their scope; several “means” may be represented by the same or different item(s) or implemented structure or function; any of the disclosed devices or portions thereof may be combined together or separated into further portions unless specifically stated otherwise. Where one claim refers to another claim, this may indicate synergetic advantage achieved by the combination of their respective features. But the mere fact that certain measures are recited in mutually different claims does not indicate that a combination of these measures cannot also be used to advantage. The present embodiments may thus include all working combinations of the claims wherein each claim can in principle refer to any preceding claim unless clearly excluded by context.

1. A system for automated unloading AFM-probes from a source probe carrier and loading the probes after being individually characterized into a destination probe carrier for use by an AFM-device, or directly into an AFM-device, wherein each probe of the AFM-probes comprises a cantilever and a tip, the system comprising:
a cantilever characterization station for characterizing a cantilever of individual probes;
a tip characterization station for characterizing a tip of individual probes;
a probe manipulator to transfer AFM-probes to the destination probe carrier or directly into the AFM-device.

2. The system of claim 1, further comprising a cleaning station for cleaning cassettes and/or individual probes by one or more of ultrasonic submersion, plasma cleaning or a chemical cleaning process.

3. The system according to claim 1, or wherein the probe manipulator is configured to separate individual probes from a source probe carrier with a plurality of probes.

4. The system according to claim 1, wherein the cantilever characterization station is configured to characterize a cantilever of an individual probe contained in the source probe carrier

5. The system according to claim 4, characterized in that the cantilever characterization station comprises a Laser Doppler Vibrometer for determining dynamical and/or mechanical properties for each probe cantilever in the source probe carrier.

6. The system according claim 1, characterized in that the tip characterization station is configured to characterize a tip of an individual probe contained in the source probe carrier.

7. The system according to claim 6, characterized in that the tip characterization station comprises a Laser Doppler Vibrometer for characterizing the tip.

8. The system according to claim 1, wherein the probe manipulator is configured to automatically remove probes from the source probe-carrier by one or more of the processes dicing, lasercutting, mechanical yielding, torsion, etch, and/or vacuum manipulation.

9. The system according to claim 1, wherein the cantilever characterization station is configured to characterize an AFM probe cantilever on the basis of one or more of the properties: eigenfrequency/eigenfrequencies, stiffness, and shape.

10. The system according to claim 1, wherein the tip characterization station is configured to characterize an AFM probe tip on the basis of one or more of the properties: tip shape, stiffness, radius, length, adhesion, conductivity, permeability, and aspect ratio.

11. The system according to claim 1, further comprising an optical inspection station for performing an optical inspection of one or more sides of a probe.

12. The system according to claim 11, wherein the optical inspection station is configured to perform a characterization with respect to cleanliness, recognizing markings/IDs, shapes, and/or defects, and/or to provide navigation information indicative for a position and/or orientation of the probe.

13. The system according to claim 1, which is further configured to perform a functional characterization.

14. The system according to claim 1, comprising a controller and a probe characteristics memory, the controller being configured to store in the probe characteristics memory for each probe the location of the probe as well as the data characterizing the probe.

15. The system according to-one claim 1, which is configured to provide information for use by an AFM-device indicative for the location of the probe in the destination probe carrier as well as the data characterizing the probe.

16. The system according to claim 15, wherein said information is accessible to an AFM-device using the probe in that it is encoded into a QR code provided on a surface of the destination probe carrier and/or written into a data carrier that is embedded into the destination probe carrier and/or stored in a database accessible to the AFM-imaging device via communications/networking technology (internet).

17. A method for automated unloading AFM-probes from a source probe carrier and loading the probes after being individually characterized into a destination probe carrier for use by an AFM-device or directly loading a probe into an AFM-device, wherein each probe of the AFM-probes comprises a cantilever and a tip, the method comprising:
receiving a source probe carrier;
characterizing a cantilever of individual probes received in the source probe carrier;
characterizing a tip of individual probes received in the source probe carrier;
transferring AFM-probes to a destination probe carrier or directly loading a probe into an AFM-device.

18. A record carrier comprising a program with instructions to cause a programmable apparatus to perform the steps of claim 17.

19. The system of claim 14, wherein the data characterizing the probe comprises a measured value CL(i) for stiffness of the cantilever and characteristics TP(i) of the tip.

20. The system of claim 15, wherein the data characterizing the probe comprises a measured value CL(i) for stiffness of the cantilever and characteristics TP(i) of the tip.
